(19) United States
(12) Patent Application Publication
(10) Pub. No.: US 2007/0013520 A1
(43) Pub. Date: Jan. 18, 2007

(54) Printhead with RFID antenna

(76) Inventors: Kevin Conwell, Fairfield, OH (US); Matt Adams, Mason, OH (US)

Correspondence Address: Orum & Roth LLC, Ste 1616, 53 W Jackson Blvd, Chicago, IL, 60604, US

(21) Appl. No.: 11/365,480

(22) Filed: Mar. 1, 2006

Related U.S. Application Data
(60) Provisional application No. 60/657,879, filed on Mar. 1, 2005.

(51) Int. Cl. G08B 13/14

(52) U.S. Cl. 340/572.1

(57) ABSTRACT

A printhead with a built-in antenna. The built-in antennaa allows for close proximity between the media and the antenna, particularly as media passes under the printhead. The RFID antenna embedded in the print head eliminates the potential interference and crosstalk between the smart labels. The built-in antenna at the print station allows for RF writing and printing at the same time. The close proximity of the antenna to the RFID tag also allows for reduced power, which is an advantage in portable devices that often have limited battery life. Having a RFID antenna built in to the print head, also allows for a printer with smaller dimensions. Further, the printer assembly and repairs are quicker because there is no need for an additional patch antenna component.

This application claims the benefit of U.S. Provisional Application No. 60/657,879 filed 1 Mar. 2005 and entitled Print Head with RFID Antenna.

### BACKGROUND OF THE INVENTION

1. Field Of The Invention

The present invention relates to printers. More specifically it relates to an antenna built into a printhead for reading and/or writing to smart labels.

2. Description Of Related Art

Prior art RFID labels were written to using separate patch antennas located above the media path, the antenna itself is either in the printer or remote from the printer. Using a separate patch antenna has several disadvantages. Due to space constraints and mechanical restriction, especially in small portable units, the placement of the separate patch antenna must take into consideration the size, length and transponder insert location within the smart label. Further, if the patch antenna is located at a remote location from the print head, the sequence of printing and encoding must also be considered. The further the antenna is located from media path, the large the RF field needs to be so the RF field will reach the transponder insert within the label or tag material. However, there are government regulatory guidelines that typically limit the RF power that may be emitted by a separate patch antenna. There is a need for an antenna that is located close to the media path.

### SUMMARY OF THE INVENTION

The present invention is a more efficient method of using an antenna in a printer for encoding smart labels with RFID transponder inserts. RFID smart labels are useful in on-demand smart label printers.

The present invention is a print head with a built-in antenna. The built-in antenna allows for close proximity between the media and the antenna, particularly as the media passes under the print head. By embedding the RFID antenna in the print head potential interference is eliminated, as is the crosstalk between the smart labels. The built-in antenna at the print station allows for RF writing and printing at the same time.

The close proximity of the antenna to the RFID tag also allows for reduced power, which is an advantage in portable devices that often have limited battery life. Further, having a RFID antenna built in to the print head, allows for the printer to be smaller. Further, the printer assembly and repairs are quicker because there is no need for an additional patch antenna component.

### BRIEF DESCRIPTION OF THE FIGURES

FIG. 1 is a prior art printer system with an antenna remote from the print head.

FIG. 2 is an inventive printer system with an RFID and antenna embedded within the print head.

### DETAILED DESCRIPTION OF THE INVENTION

Smart labels or tags are labels or lags that have an embedded radio frequency transponders (known as RFID tags, inserts, insets or inlays) or an RFID tag laminated or otherwise applied to one surface. RFID tags generally include an antenna and integrated memory circuit with read/write capability. RFID tags are used to store digital information, such as all electrically erasable programmable read-only memory (EEPROM) or similar electronic information. Active RFID tags include their own radio transceiver and power source, such as a battery, and are generally sealed within a molded plastic housing or button. Passive RFID tags are energized to transmit and receive data by an electromagnetic field and do not include a radio transceiver or power source. As a result passive RFID tags are small, but they have a limited range, resolution and data storage capacity.

RFID tags can be laminated to and/or inserted into paper or synthetic label/tag stock. Label stock is typically backed with a pressure sensitive adhesive for applying the printed label to a carton, automobile, pallet, piece or baggage or luggage, parcel or other article to be tracked.

The present invention is a more efficient method of using an antenna 20 in a printer for encoding smart labels 10 with RFID transponder inserts. Printer has a print head 22 with a built-in antenna 20. Built-in antenna 20 allows for close proximity between media 10 and antenna 20, particularly as media 10 passes under the print head 22. By embedding RFID antenna 20 into print head 22 potential interference is eliminated, as is the crosstalk between smart labels 10. Built-in antenna 10 at the printhead 22 allows for RF writing and printing at the same time.

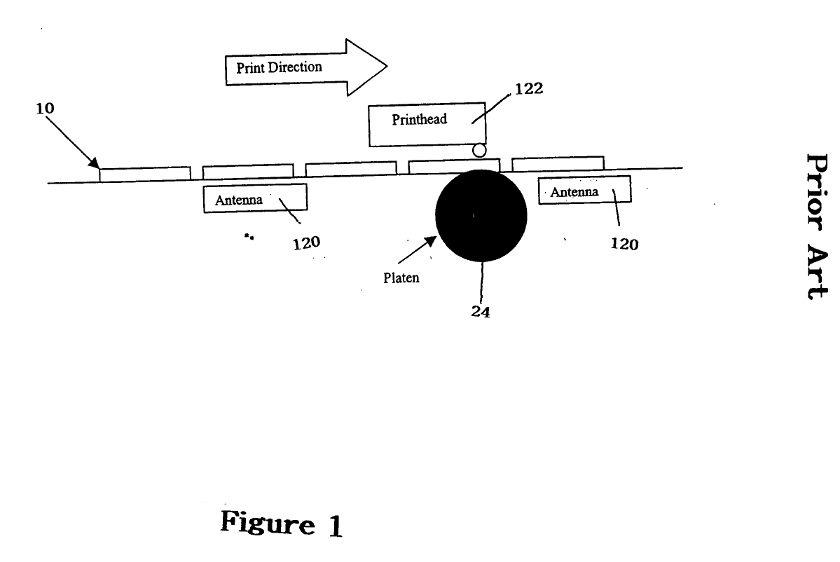

Referring to FIG. 1, a prior art printing system is shown. Labels 10 or other media with an embedded RFID tag are transported along a media path in the print direction. Labels 10 pass an antenna 120 located adjacent to the media path. Antenna 120 writes to the embedded RFID tag. Labels are printed as they pass a printhead 122, here a thermal printer in which the labels pass between print head 122 and platen 24 is shown. Antenna 120 is located after printhead 122 in some prior art systems.

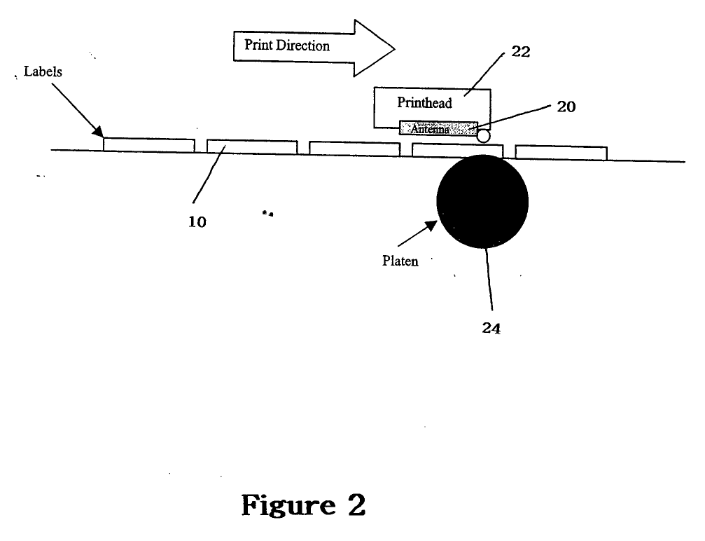

Referring to FIG. 2, the inventive printhead 22 is shown. Labels or media 10 having an RFID tags are transported along a media path. Labels 10 pass under print head 22 and are printed at substantially the same time antenna 20 writes and/or reads the RFID tag. The preferred embodiment of the present invention has antenna 20 built directly into thermal print head 22. The RF encoder board can be an onboard print head component 22 or a separate board within printer that is then connected to antenna 20 through print head cable. While thermal printers are preferred the design is not limited to thermal printers. Other printers such as inkjet printers, dot matrix printers, impact printers, laser printers, label printers, page printers, form printers and/or other printer technologies can be used in the inventive printer system.

The close proximity of antenna 20 to the RFID tag reduces the power needed for antenna 20 to communicate with the embedded RFID tag. Lower power reduces the chance of RF signals leaking out of the printer. By using lower power source, it is easier to contain the RF signal to the confines of the print body as a result the need for additional shielding in also reduced, or eliminated.

The close proximity of antenna 20 to the label 10 reduces the chance of crosstalk between a individual RFID tags. Close proximity of the antenna 20 to the label 10 also reduced the potential for interference and tag detuning or decoupling by other metal or plastic components and panels close to the media path. The internal metal and plastic construction of a label printer can interfere with the signals emitted by a remote patch antenna 120. By having the antenna 20 close to the label interference as a potential problem is eliminated. Further optionally a waveguide channel or conduit can be utilized to focus the area of energy even further for very small smart labels.

By having antenna-20 in close proximity to smart label 10 a single antenna 20 may be used to read multiple frequencies. For example, a 2.45 GHz antenna close to a 915 MHz tag can communicate because 2.45 GHz is a multiple of the 915 MHz frequency.

Reduced power needs are also an advantage in portable print devices that often have limited battery life. Further, having a RFID antenna 20 built in to print head 22 is a more compact and integrated allowing for the printer to be smaller.

1. A printer comprising:
a printhead with an RFID antenna and a platen roller.

2. The printer of claim 1 wherein the antenna is built directly into thermal print head.

3. The printer of claim 2 further comprising an RF encoder board onboard the print head.

4. The printer of claim 2 further comprising an RF encoder board within printer that is connected to the antenna by a print head cable.
